(19) United States
(12) Patent Application Publication
(10) Pub. No.: US 2006/0277340 A1
(43) Pub. Date: Dec. 7, 2006

(54) System and method for providing layered profiles

(76) Inventors: David B. Mar, Austin, TX (US); Anthony Fernandez, Cedar Park, TX (US)

Correspondence Address: BAKER BOTTS, LLP, 910 LOUISIANA, HOUSTON, TX, 77002-4995, US

(21) Appl. No.: 11/145,323

(22) Filed: Jun. 3, 2005

(51) Int. Cl. G06F 13/00

(52) U.S. Cl. 710/104

(57) ABSTRACT

A system and method for configuring systems uses layered profiles. A separate profile is selected for multiple characteristics of a particular system. Each selected profile may then be used to generate a configuration layer associated with each selected profile. The system may then use multiple configuration layers to configure a system, resulting in a system configured according to the selected profiles.

### TECHNICAL FIELD

The present invention is related to the field of computer systems and more specifically to a system and method for providing layered profiles.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Some information handling systems include software solutions (including enterprise software solutions) that are highly configurable. Such systems typically require onsite consultants to customize and modify deployments and configuration to meet specific customer needs. In some instances, a standardized configuration that has been previously validated and tested may be used. Such standardized configurations may be geared to enhance certain selected system characteristics.

For instance, a configuration may be based on a system where high availability is critical or, alternatively, may be based on a need to minimize system and operation cost. Other standard configurations may be designed to enhance optimal performance versus data redundancy or high security versus ease of maintenance.

However, the use of such standardized configurations has a number of drawbacks. Often, optimizing system characteristics may adversely effect another area of the system. In order to tailor a system configuration to a user's need, it is often necessary for a technician or consultant to modify the system configuration, typically requiring significant time and expense.

### SUMMARY OF THE INVENTION

Therefore a need has arisen for an improved system and method for configuring information handling systems.

The present disclosure describes a system and method for configuring systems using layered profiles. A separate profile may be selected for multiple characteristics of a particular system. Each selected profile may then be used to generate a configuration layer associated with each selected profile. The system may then use multiple configuration layers to configure a given system, resulting in a system configured according to the selected profiles.

In one aspect, an information handling system is disclosed with a rebuild partition that includes a plurality of configuration resources stored therein and a configuration stack. The configuration stack includes at least two configuration layers each of which are able to configure a portion of the information handling system according to a selected profile.

In another aspect, a rebuild partition for configuring an information handling system is disclosed that includes multiple configuration resources and a configuration stack including at least two configuration layers. Each configuration layer is able to configure a portion of the information handling system according to a selected profile.

In yet another aspect, a method is disclosed that includes selecting at least one configuration profile for an information handling system and developing at least two configuration layers based upon the selected configuration profile. The method also includes configuring a portion of the information handling system by running scripts associated with each configuration layer.

The present disclosure includes a number of important technical advantages. One technical advantage is providing two or more configuration layers for configuring an information handling system. The configuration layers allow the system configuration to be tailored to a detailed configuration profile selected by a user. Additional advantages will be apparent to those of skill in the art and from the figures, description and claims provided herein.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 shows an information handling system according to teachings of the present disclosure;

FIG. 2 shows a rebuild partition according to teachings of the present disclosure;

FIG. 3 shows a diagram of configuration profile information according to teachings of the present disclosure;

FIG. 4 shows a flow diagram of a method according to teachings of the present disclosure;

FIG. 5 shows a flow diagram of a method according to teachings of the present disclosure; and

FIG. 6 shows a flow diagram of a method according to teachings of the present disclosure.

### DETAILED DESCRIPTION OF THE INVENTION

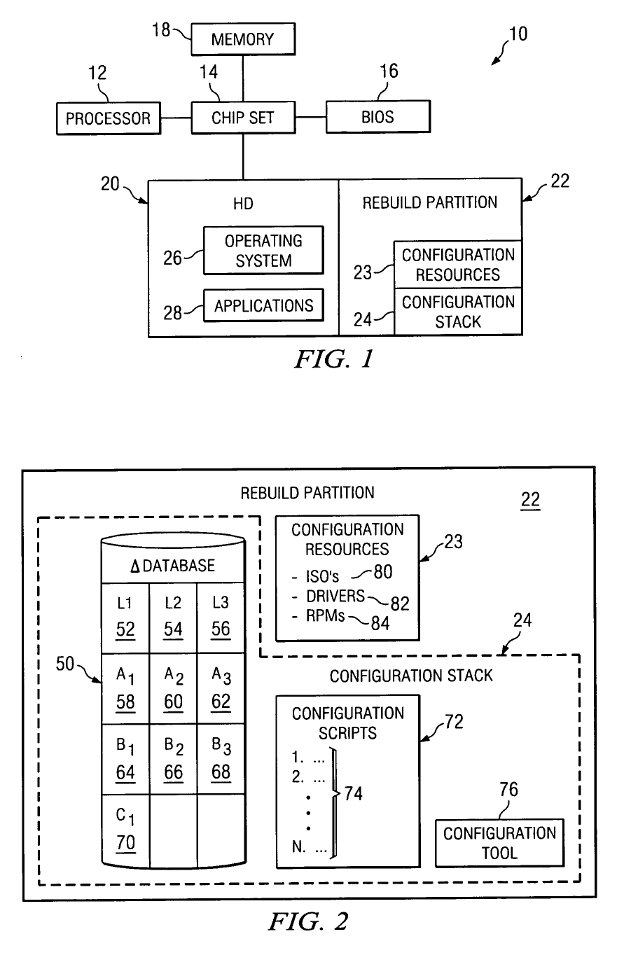

Preferred embodiments of the invention and its advantages are best understood by reference to FIGS. 1-6 wherein like numbers refer to like and corresponding parts and like element names to like and corresponding elements.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Now referring to FIG. 1, an information handling system, generally indicated at 10, is shown. Information handling system 10 generally includes processor 12, chipset 14, basic input output system (BIOS) 16, memory 18 and storage resource 20. Chip set 14 is coupled to processor 12, storage resource 20, BIOS 16 and memory 18.

System 10 may operate by executing BIOS 16 for a system firmware (not expressly shown) in response to being powered up or reset. BIOS 16 identifies and initializes the components of system 10 and causes operating system 26 to be booted. Operating system 26 may allow the user of system 10 to initiate and run one or more applications 28 on system 10. Applications 28 may be stored on storage resource 20 or may be stored on a remote storage resource (not expressly shown) communicatively coupled with system 10. System 10 may be networked with additional information handling systems or components.

In the present embodiment, storage resource 20 is a system hard drive. Hard drive 20 includes rebuild partition 22 that preferably provides the necessary resources for configuring system 10 as described herein. Rebuild partition may also be referred to as a “re-deployment partition.” Rebuild partition 22 generally includes configuration resources 23 and configuration stack 24. Configuration resources 23 preferably include all necessary files for configuring information handling system 10 as well as operating system 26 and one or more of system applications 28. Configuration stack 24 may preferably provide suitable instructions to customize and save multiple configuration layers as described below.

Operating system (O/S) 26 and applications 28 are also stored on hard drive 20. O/S 26 may be, for instance, a Windows or Linux operating system. Applications 28 may include, for example, PeopleSoft, SAP, Oracle DB, Oracle RAC Clusters or an Oracle Application Server application or any other application suitable for configuration as described herein.

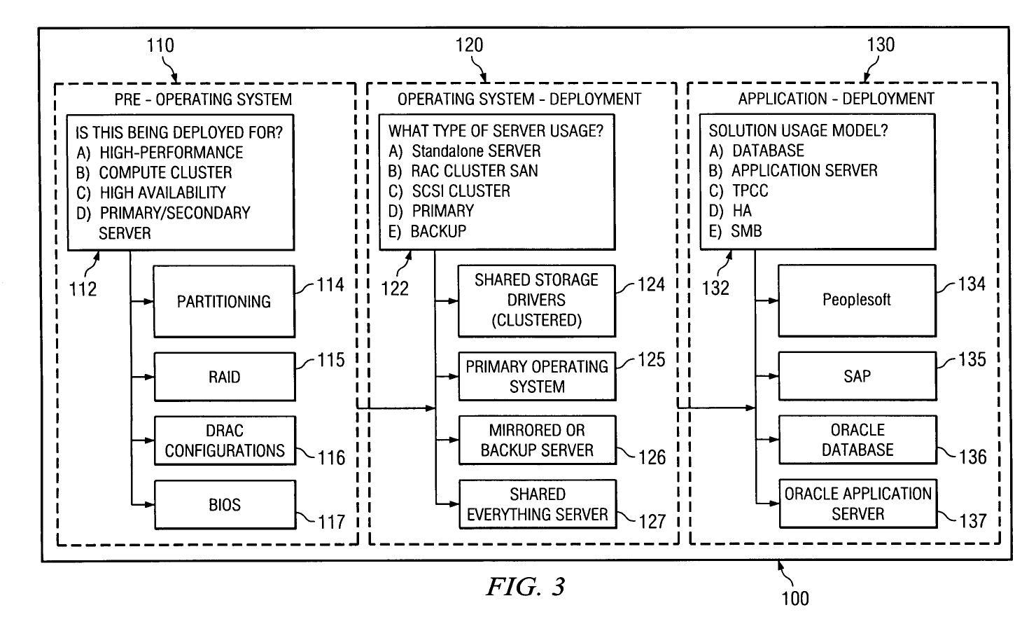

Now referring to FIG. 2, a more detailed diagram of rebuild partition 22 is shown. Rebuild partition 22 generally includes configuration resources 23 and configuration stack 24. Configuration stack 24 generally includes configuration layer database 50 (which may also be referred to herein as delta database), configuration script database 72 and configuration tool 76. Configuration tool 76 preferably provides a user interface operable to allow a user to select one or more profiles (as described in greater detail with respect to FIG. 3, below). For example, configuration tool 76 may query a user with respect to the anticipated deployment for system 10. Such information is then preferably used to generate multiple profile layers, such as first layer 52, second layer 54 and third layer 56 stored in configuration database 50.

Configuration database 50 stores configuration layers 52, 54 and 56. In the present preferred embodiment first configuration layer 52 corresponds to configuration instructions for configuring pre-O/S aspects of system 10 according to selected profiles as described in FIG. 3, below. Configuration database 50 preferably stores all changes made to first configuration layer 52. For example, configuration database 50 stores the original configuration layer (A₁) 58, a subsequent revised first configuration layer (B₁) 64, and a still further subsequent revised first configuration layer (C₁) 70. Configuration database 50 may also store current and previous configuration layer information for second configuration layer 54 and third configuration layer 56.

In the present preferred embodiment, second configuration layer 54 corresponds to configuration instructions for configuring operating system 26 of system 10 and third configuration layer 56 corresponds to configuration instructions for configuring one or more of applications 20. Additionally, configuration database 50 preferably stores the original selected configuration layers (A₂)60 and (A₃) 62 as well as subsequent configuration layers (B₂) 66 and (B₃) 68.

In this manner, configuration database 50 records previous configuration layer information. Each time a configuration layer is modified, the new configuration layer (or modification of the existing layer) is updated within configuration database 50. Additionally, the time and date of each modification on new configuration may also be recorded within configuration database 50 (not expressly shown).

Accordingly, configuration database 50 allows a base point to be created and then each subsequent change (or delta) for each configuration layer to be iteratively recorded. Configuration database 50 may provide the ability to roll-back to a particular instant in time before a particular profile or layer has been applied or a way to apply iteratively multiple profiles or layers forward. Configuration database 50 may allow for layers to be un-applied backwards, for a determination to be made of whether a layer has already been applied, as well as the ability to recovery back to an initial factory configuration. Configuration database 50 may also provides a way to understand what time certain layers (including software patches) were applied.

Additionally, configuration database 50 may allow for the execution of certain layers (which may be patches or profiles) and the exclude or others. Additionally, configuration database 50 may allow other server to discover the layer (which my include specific patches or profiles) stored thereon.

Each configuration layer includes one or more scripts 74 stored within scripts database 74. Each script 74 includes an instruction or series of instructions for configuration resources 23 to configure the particular portions of information handling system 72. The use of scripts 74 provides a way to deploy heterogeneous systems as opposed to homogenous image based systems. Scripts 74 also provide a repeatable way to re-install an entire OS. The use of multiple layers and scripts facilitates a configuration that is hardware independent and or operating system independent.

Scripts 74 may leverage configuration resources 23 (including ISO images 80) which allows the same scripts to deploy on any node with any geometry. Scripts 74 may load particular drivers for hardware or may provide points to reference places if software is not available. Scripts 74 may be independent and may be saved to execute certain tasks such as create partitions with optimal space, optimal speed, highest availability, etc.

The present disclosure contemplates the use of extensible hooks allow users to read the scripts 74 that get executed to deploy the system. In such instances, users may modify scripts 74 and tailor them to their own needs or may write their own scripts to facilitate the installation of the operating system 26.

In the present embodiment, configuration resources 23 includes ISOs 80, Drivers 82 and RPMs 84. ISOs 80 may include, for example, W2k3-SP1.iso, Redhat40_disc1.iso, Redhat40_disc2.iso, Redhat40_disc3.iso, and Redhat40_disc4.iso. RPMs 84 may include, for example: dkms-2.0.3-1.noarc.rpm, qla2x00-v7.04.00-1dkms.noarch.rpm, and percsnmp-4.09-1.i386.rpm.

In alternate embodiments, configuration resources 23 may include fewer or additional resources. In one embodiment ISOs 80 may comprise unmodified copies of the installation CD for operating system 26 or applications 28. For example, if windows were the operating system 26, the installation CD image would be stored within configuration resources 23 as opposed to an image of a deployed windows operating system.

Now referring to FIG. 3, a diagram of configuration profile information indicated generally at 100, is shown. Configuration information 100 includes pre-operating system (pre-OS) information 110, operating system deployment information 120, and application deployment information 130.

Pre-operating system information 110 includes profile or characteristic information 112. Profile information 112 may be used to query a user to determine the pre-operating deployment profile for a particular system. For instance, deployment profile 112 may be used to determine whether a pre-operating system is being deployed for high performance, for a computer cluster, for high availability or as a primary or secondary server. Pre-operating systems, profiles 112 are then used to develop first layer 52. Pre-operating system information 110 further includes partitioning block 114, RAID block 115, DRAC configurations block 116 and BIOS block 117.

Each block refers to the logic which performs the specific profile. For instance, in a High Availability layer, RAID block 115 may perform the function of setting a RAID to the highest redundancy possible for that particular system, i.e; RAID 10. Partitioning block 114 may provide profiles for different partition layouts. For example, one profile for partitioning might be pre-configured for a linux OS that spreads the OS across multiple drives for optimal disk access. Another partitioning profile might be set such that the disks are setup to have software mirroring on two separate partitions.

A choice of a profile such as high performance affects the use of each potential block. For instance; in order to reach high performance on a system, some compromises may have to be made such as lowering the RAID level for a particular system. For instance, a profile which is tailored for high availability (such as, for instance, RAID 10) might suffer on the performance side since reads/writes to a RAID 10 disk does not yield the highest performance. In such cases, a compromise can be reached by the user by lowering the high availability to RAID 5 and thereby increasing performance.

Likewise a selection for high availability may affect how each of these components is configured. In the present embodiment blocks 114 through 117 are shown. In alternate embodiments more or fewer pre-operating system information blocks may be included within pre-operating system information 110. For instance; an Ethernet Devices block may be added, which may be configured on a High Available system to set NIC bonding. (NIC bonding is a high availability technique which combines two or more Ethernet devices to behave as one.)

Operating system deployment information 120 includes operating system profile information 122. Profile information 122 may be used to query a user to determine the type of usage anticipated for a system. In the present exemplary embodiment, operating system profile 122 may be used to develop second configuration layer 122. For instance, profile information 122 may determine whether or not the system will be a stand alone server, a RAC cluster SAN, a SCSI cluster, a primary server or a back-up server. Operating system deployment information 120 further includes shared storage driver block 124, primary operating system block 125, mirrored or back-up server block 126 and shared everything server block 127. Each selected profile may change the drivers and setup of the operating system for the particular user or system. This layer of configuration profiles lays on top of pre-OS profiles 112.

Application deployment information 130 includes Application profile information 132. Solution usage application profile information 132 may be used to determine an application usage model for a system such as a database, an application server, a TPC-C high availability (HA) or Server Message Block (SMB). TPC-C is an Online Transaction Processing (OLTP) benchmark and SMB is a protocol to share information such as files, printers and serial ports between systems.

In the present embodiment, Application profile information 132 may preferably be used to develop third configuration layer 56. Application deployment information 130 further includes PeopleSoft block 134, SAP block 135, Oracle DB block 136 and Oracle application server block 137.

The present embodiment shows configuration information 100 divided into three types of information (which may also be referred to as modules or layers.) However, the present disclosure contemplates configuration information 100 being organized in any suitable number of layers. Accordingly, in alternate embodiments configuration information 100 may be organized in more or fewer layers. Additionally, sublayers within each layers may also be included.

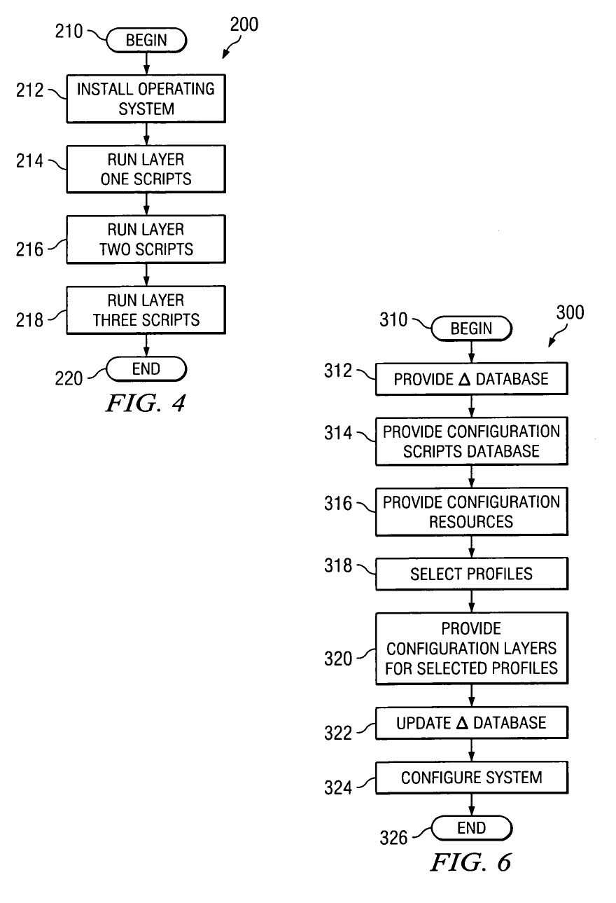

Now referring to FIG. 4, a flow diagram of method 20 is shown. Method 200 begins 210 with the installation of an operating system 212. Next first layer scripts are run 214 followed by second layer scripts 216 and third layer scripts 218. The method then ends 220. In the present embodiment, first layer scripts 214 may be run for configuring pre-operating system applications, second layer scripts 216 may be run for configuring operating system characteristics and third layer scripts 218 may be run for configuring one or more applications that may be run by the system.

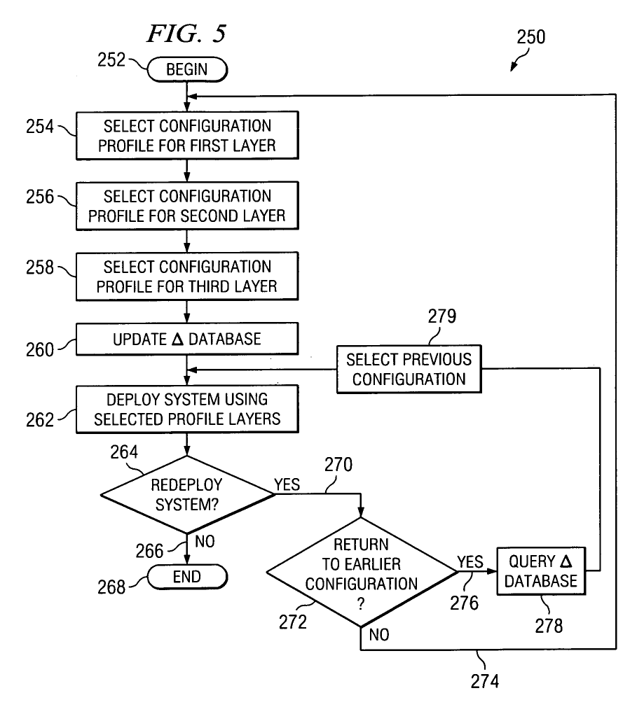

Now referring to FIG. 5, a flow diagram of method, indicated generally at 250, is shown. Method 250 begins 252 by selecting a configuration profile for a first configuration layer 254. Next a configuration profile for a second layer is selected 256, followed by the selection of a configuration profile for a third layer 258. Next the configuration database is updated 260. The system may then be deployed using the selected profile layers 262.

Following step 262, it is determined whether or not to re-deploy the system 264. In the event that the system is not re-deployed 266, the method ends 268. However, in the event that a system is redeployed 270, it is determined whether or not to return to an earlier or previous configuration 272. If it is decided to return to an earlier configuration 276, the configuration database is queried 278 and a previous configuration is selected 279. If returning to an earlier configuration is not selected 274 the method returns to step 254 wherein new configuration profiles are selected.

Now referring to FIG. 6, a flow diagram of a method indicated generally at 300 is shown. Method 300 begins 310 by providing a configuration database 312, a configuration script database 314, and configuration resources 316. Next, the method may proceeds by selecting configuration profiles 318. Next the method provides configuration layers corresponding to each selected profile 320 and updating a configuration database 322 to record the provided configuration layers. The system is then configured 324 and the method ends 326.

Although the disclosed embodiments have been described in detail, it should be understood that various changes, substitutions and alterations can be made to the embodiments without departing from their spirit and scope.

What is claimed is:

1. An information handling system comprising:
a rebuild portion including a plurality of configuration resources stored therein and a configuration stack; and
the configuration stack including at least two configuration layers each operable to configure a portion of the information handling system according to a selected profile.

2. An information handling system according to claim 1, wherein the configuration stack comprises a configuration script database having a plurality of configuration scripts and each layer having at least one selected configuration script associated therewith.

3. An information handling system according to claim 2 further comprising a configuration tool operable to allow a user to select one or more selected profiles and generate the configuration layers according to the selected profiles.

4. An information handling system according to claim 1 further comprising a configuration layer database for storing the at least two configuration layers.

5. An information handling system according to claim 4 wherein the configuration layer database is operable to store at least one previously selected configuration layer for each configuration layer.

6. An information handling system according to claim 1 further comprising:
a first configuration layer operable to configure a Pre-Operating System portion of the information handling system according to a selected pre-operating system profile;
a second configuration layer operable to configure an operating system of the information handling system according to a selected operating system profile; and
a third configuration layer operable to configure at least one application associated with the information handling system according to a selected application profile.

7. An information handling system according to claim 1 wherein the plurality of configuration resources comprises at least two configuration resources selected from the group consisting of ISOs, Drivers and RPMs.

8. An information handling system according to claim 1 wherein at least one configuration layer comprises a pre-operating system configuration layer.

9. An information handling system according to claim 8 comprising the pre-operating system configuration layer is operable to configure at least one selected from the group consisting of partitioning, RAID, DRAC and Basic Input Output System (BIOS), according to a selected profile.

10. An information handling system according to claim 1 wherein at least one configuration layer comprises an operating system configuration layer.

11. An information handling system according to claim 10 comprising the operating system configuration layer operable to configure at least one selected from the group consisting of shared storage drivers, Primary Operating System, Back-up server and shared-everything server according to a selected profile.

12. An information handling system according to claim 1 wherein at least one configuration layer comprises an application configuration layer operable to configure at least one application according to a selected profile.

13. A rebuild partition for configuring an information handling system comprising:
a plurality of configuration resources; and
a configuration stack including at least two configuration layers each operable to configure a portion of the information handling system according to a selected profile.

14. A rebuild partition according to claim 13 wherein the configuration stack comprises a configuration script database having a plurality of configuration scripts and each layer having at least one selected configuration script associated therewith.

15. A rebuild partition according to claim 13 wherein the configuration layer database is operable to store at least one previously selected configuration layer for each configuration layer.

16. A method comprising:
selecting at least one configuration profile for an information handling system;
developing at least two configuration layers based upon the selected configuration profile; and
configuring a portion of the information handling system by running scripts associated with each configuration layer.

17. A method according to claim 16 further comprising providing a configuration layer database to store at least one previously selected configuration layer for each configuration layer.

18. A method according to claim 16 wherein:
selecting at least one configuration profile comprises:
selecting a pre-O/S configuration profile;
selecting an O/S configuration profile; and
selecting an application configuration profile;
developing a pre-O/S configuration layer based upon the selected pre-O/S configuration profile;
developing an O/S configuration layer based upon the selected O/S configuration profile; and
developing an application configuration layer based upon the selected application configuration profile.

19. A method according to claim 16 further comprising providing a scripts database for storing a plurality of configuring scripts operable to be associated with the configuration layers.

20. A method according to claim 17 comprising re-deploying the information handling system using the at least one previously selected configuration layer.
